(19) United States
(12) Patent Application Publication
(10) Pub. No.: US 2020/0341341 A1
(43) Pub. Date: Oct. 29, 2020

(54) ELECTROCHROMIC MATERIAL AND METHOD OF MANUFACTURING THE SAME AND ELECTROCHROMIC DEVICE AND OPTICAL DEVICE AND ELECTRONIC DEVICE

(71) Applicant: SAMSUNG ELECTRONICS CO., LTD., Suwon-si (KR)

(72) Inventors: Haeng Deog KOH, Hwaseong-si (KR); Ha Jin KIM, Hwaseong-si (KR); Min Jong BAE, Yongin-si (KR)

(21) Appl. No.: 16/733,711

(22) Filed: Jan. 3, 2020

(30) Foreign Application Priority Data
Apr. 29, 2019 (KR) 10-2019-0049882

(51) Int. Cl. G02F 1/1524; C09K 9/00; C01G 53/04

(52) U.S. Cl. CPC G02F 1/1524; C09K 9/00; C01G 53/04; C01P 2004/16; B82Y 20/00; C01P 2006/12; C01P 2006/40; C01P 2006/60; C01P 2006/16

(57) ABSTRACT

An electrochromic material including a nanostructure including a nickel oxide wire which is three-dimensionally interconnected wherein a thickness of the nickel oxide wire is less than about 10 nanometers, and an electrochromic device, an optical device, and an electronic device including the same.

### CROSS-REFERENCE TO RELATED APPLICATION

This application claims priority to Korean Patent Application No. 10-2019-0049882 filed on Apr. 29, 2019, and all the benefits accruing therefrom under 35 U.S.C. § 119, the content of which in its entirety is herein incorporated herein by reference.

### BACKGROUND

### 1. Field

An electrochromic material and a method of manufacturing the same, an electrochromic device, an optical device, and an electronic device are disclosed.

### 2. Description of the Related Art

Electrochromism refers to a phenomenon in which a color reversibly changes in response to the direction of an electric field when a voltage is applied. A material having such property, that is, a material whose optical characteristic may reversibly change through an electrochemical redox reaction, is called an electrochromic material. An electrochromic material may not show color until an electric field is applied thereto, or conversely it may show color when no electric field is applied and when an electric field is applied, it loses the color.

An electrochromic material has been used in to an electrochromic device that changes light transmission characteristics depending on a voltage.

An electrochromic device may be used in smart windows. Recently it has also been used in a display device due to excellent portability and light weight.

### SUMMARY

An embodiment provides an electrochromic material exhibiting improved performance.

Another embodiment provides an electrochromic device including the electrochromic material.

Another embodiment provides an optical device including the electrochromic material or the electrochromic device.

Another embodiment provides an electronic device including the electrochromic material, the electrochromic device, or the optical device.

According to an embodiment, an electrochromic material includes a nanostructure including a nickel oxide wire which is three-dimensionally interconnected, wherein a thickness of the nickel oxide wire is less than about 10 nanometers (nm).

The nanostructure may be porous.

The nanostructure may be a nanoporous structure or a mesoporous structure.

A pore size of the nanostructure may be less than or equal to about 10 nm.

A surface area of the nanostructure may be greater than or equal to about 100 square centimeters per gram (cm²/g).

A thickness of the nickel oxide wire may be about 1 nm to about 8 nm.

The nanostructure may be a triply periodic bicontinuous structure.

The nanostructure may have a gyroid network morphology.

According to another embodiment, a method of manufacturing an electrochromic material includes preparing a template having a void which is three-dimensionally and bicontinuously interconnected, providing nickel to the void of the template, removing the template, and oxidizing the nickel to form a nanostructure including a nickel oxide wire which is three-dimensionally interconnected. The thickness of the nickel oxide wire is less than about 10 nm.

The preparing of the template may include performing microphase separation using a mixture of a block copolymer and a siloxane precursor. The block copolymer may have a weight average molecular weight of less than or equal to about 10,000 grams per mole (g/mol) and a Flory-Huggins interaction parameter of greater than or equal to about 0.3.

The block copolymer may include an ethylene oxide block and a propylene oxide block, the ethylene oxide block may be included in an amount of greater than or equal to about 20 volume % and less than about 50 volume % with respect to the block copolymer, and the microphase separation may be phase-separation into a hydrophilic part including a structural unit derived from the siloxane precursor and the ethylene oxide block and a hydrophobic part including the propylene oxide block.

The providing of the nickel to the void of the template may be performed by an electroplating or solution process.

According to another embodiment, an electrochromic device includes a first electrode and a second electrode facing each other, an electrochromic material on at least one of the first electrode or the second electrode, and an electrolyte between the first electrode and the second electrode, wherein the electrochromic material includes a nanostructure including a nickel oxide wire which is three-dimensionally interconnected, e.g., in the form of a three-dimensional framework including a plurality of nickel oxide wires, and a thickness of the nickel oxide wire is less than about 10 nm.

A contrast ratio of the electrochromic device at 550 nm may be greater than or equal to about 80.

According to another embodiment, an electronic device including the electrochromic device is provided.

According to another embodiment, an optical device including the electrochromic material is provided.

According to another embodiment, an electronic device including the optical device is provided.

An improved contrast ratio may be achieved by increasing a redox reactivity.

### BRIEF DESCRIPTION OF THE DRAWINGS

FIG. 1 is a schematic view showing a nanostructure according to an embodiment,

FIG. 2 is a SEM photograph showing an enlarged nanostructure according to an embodiment,

FIG. 3 is a schematic view showing an example of an electrochromic device according to an embodiment,

FIG. 4 is a TEM photograph of a nanostructure including a nickel oxide wire of Preparation Example 1,

FIG. 5 is a TEM photograph of a nanostructure including a nickel oxide wire of Comparative Preparation Example 3,

FIG. 6 is a graph showing transmittances of the nanostructure of Preparation Example 1 in a bleached/colored state, depending on wavelength,

FIG. 7 is a graph showing transmittances of the nanostructure of Preparation Example 2 in a bleached/colored state, depending on wavelength,

FIG. 8 is a graph showing transmittances of the nanostructure of Preparation Example 3 in a bleached/colored state, depending on wavelength,

FIG. 9 is a graph showing transmittances of the nickel oxide thin film of Comparative Preparation Example 1 in a bleached/colored state, depending on a wavelength,

FIG. 10 is a graph showing transmittances of the nickel oxide thin film of Comparative Preparation Example 2 in a bleached/colored state, depending on wavelength, and

FIG. 11 is a graph showing transmittances of the nickel oxide thin film of Comparative Preparation Example 3 in a bleached/colored state, depending on wavelength.

### DETAILED DESCRIPTION

Hereinafter, example embodiments of the present invention will be described in detail so that a person skilled in the art would understand the same. This disclosure may, however, be embodied in many different forms and is not construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an electrochromic material according to an embodiment is described.

An electrochromic material according to an embodiment includes a nanostructure including a nickel oxide wire which is three-dimensionally interconnected. In other words, the nanostructure is in the form of a three-dimensional framework including a plurality of nickel oxide wires. Thus, the interconnection of a nickel oxide wire forms a random three-dimensional framework, e.g., in the form of a random three-dimensional framework including a plurality of nickel oxide wires.

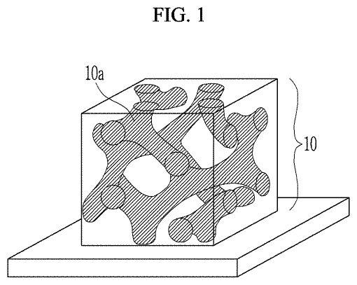

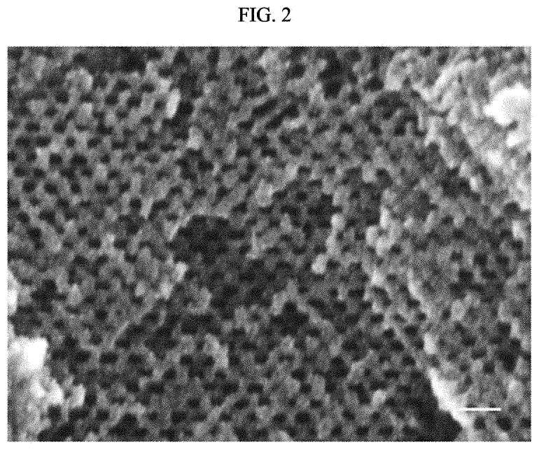

FIG. 1 is a schematic view showing a nanostructure according to an embodiment and FIG. 2 is a SEM photograph showing an enlarged nanostructure according to an embodiment (scale: 20 nm).

A nanostructure 10 may be a porous structure, for example, a nanoporous structure or a mesoporous structure. For example, the nanostructure 10 may have a plurality of pores having a size of less than or equal to about 30 nm, less than or equal to about 20 nm, or less than or equal to about 10 nm, for example about 2 nm to about 30 nm, about 2 nm to about 20 nm, or about 2 nm to about 10 nm. Herein, the size of the pore may be an average particle diameter of the plurality of pores. In an embodiment, the nanostructure 10 may have a porosity of greater than or equal to about 20 percent (%), greater than or equal to about 30%, or greater than or equal to about 50%, for example about 20% to about 80%, about 30% to about 80%, or about 50% to about 80%, based on the total volume of the nanostructure

As shown in FIGS. 1 and 2, the nanostructure 10 may be a triply periodic bicontinuous structure, for example, and may be for example a structure having a gyroid network morphology.

The nanostructure 10 may include a nickel oxide wire 10a which is three-dimensionally interconnected, and the nickel oxide wire 10a may consist of a nickel oxide, may consist essentially of metal oxide, or may comprise a nickel oxide, preferably as a main component.

The nickel oxide wire 10a may be a very thin one-dimensional shape that is three-dimensionally interconnected with each other to form a network structure. A thickness of the nickel oxide wire 10a may be less than about 10 nm, for example about 1 nm to about 9 nm, about 1 nm to about 8 nm, about 1 nm to about 7 nm, about 1 nm to about 6 nm, about 1 nm to about 5 nm, about 2 nm to about 9 nm, about 2 nm to about 8 nm, about 2 nm to about 7 nm, about 2 nm to about 6 nm, about 2 nm to about 5 nm, about 3 nm to about 9 nm, about 3 nm to about 8 nm, about 3 nm to about 7 nm, about 3 nm to about 6 nm, or about 3 nm to about 5 nm.

The nickel oxide may have hybrid conductivity capable of conducting ions and electrons, and accordingly, a redox reaction may be performed by permeation of electrolytic ions such as H⁺, Na⁺, or Li⁺. When the nickel oxide wire 10a has the aforementioned thin thickness, a substantial portion of the thickness of the nickel oxide wire 10a may work as a reaction site for a redox reaction. In an embodiment, as redox sites of the nanostructure 10 increase, the surface area of the nanostructure 10 is increased, redox reactivity is increased, and as a result, the nickel oxide wire 10a may exhibit electrochromic characteristics.

In an embodiment, the nanostructure 10 may have a surface area of greater than or equal to about 100 square centimeters per gram (cm²/g), for example greater than or equal to about 150 cm²/g, greater than or equal to about 200 cm²/g, greater than or equal to about 250 cm²/g, or greater than or equal to about 300 cm²/g, for example about 150 cm²/g to about 2000 cm²/g, about 200 cm²/g to about 2000 cm²/g, about 250 cm²/g to about 2000 cm²/g, or about 300 cm²/g to about 2000 cm²/g.

In an embodiment, the nanostructure 10 may have a redox reaction rate of greater than or equal to about 50 percent (%), for example greater than or equal to about 60%, greater than or equal to about 70%, greater than or equal to about 80%, greater than or equal to about 90%, greater than or equal to about 95%, greater than or equal to about 97%, greater than or equal to about 98%, or about 100%. Herein, the ‘redox reaction rate” of nanostructure 10 may be a percent of the oxidized thickness from the surface of the nickel oxide wire 10a relative to the thickness of the nickel oxide wire 10a. Thus, a reaction rate of about 50% means that about 50% of the thickness the thickness from the surface of the nickel oxide wire 10a is nickel oxide.

In an embodiment, the electrochromic characteristics of the nanostructure may be expressed as a contrast ratio, which is a ratio of transmittance in a colored state to transmittance in a bleached state. For example, the contrast ratio at a 550 nm reference wavelength may be greater than or equal to about 20:1, for example greater than or equal to about 30:1, greater than or equal to about 50:1, greater than or equal to about 70:1, greater than or equal to about 80, greater than or equal to about 90:1, greater than or equal to about 100:1, greater than or equal to about 200:1, or greater than or equal to about 300:1, for example about 30:1 to about 5000:1, about 50:1 to about 5000:1, about 70:1 to about 5000:1, about 80:1 to about 5000:1, about 90:1 to about 5000:1, about 100:1 to about 5000:1, about 200:1 to about 5000:1, about 300:1 to about 5000:1, about 30:1 to about 3000:1, about 50:1 to about 3000:1, about 70:1 to about 3000:1, about 80:1 to about 3000:1, about 90:1 to about 3000:1, about 100:1 to about 3000:1, about 200:1 to about 3000:1, or about 300:1 to about 3000:1.

A method of manufacturing the aforementioned nanostructure 10 is described below.

A method of manufacturing a nanostructure 10 according to an embodiment includes preparing a template having a void, supplying nickel to the void of the template, removing the template, and oxidizing the supplied nickel to form a nanostructure including a nickel oxide wire which is three-dimensionally and bicontinuously interconnected.

The template may have, for example, a periodically well-defined nanostructural void, which is three-dimensionally interconnected, and the void may be the space in which the nanostructure is formed. The template may be obtained by microphase separation of materials with different surface characteristics and may be obtained by microphase separation of a hydrophilic part and a hydrophobic part.

In an embodiment, the template may be obtained from an organic/inorganic hybrid material and may be for example obtained by microphase separation using a block copolymer-inorganic hybrid material, for example, a mixture of a block copolymer and a siloxane precursor. The organic block may be selectively removed by a heating or an etching process. As described above, a combination of the block copolymer and the siloxane precursor is important in order to obtain the nickel oxide wire 10a having a thickness of less than or equal to about 10 nm.

In an embodiment, the block copolymer may be a block copolymer with a relatively low weight average molecular weight, and may have for example a weight average molecular weight of less than or equal to about 10,000 g/mol, or, for example, about 3,000 to about 10,000 g/mol, about 4,000 to about 10,000 g/mol, about 3,000 to about 8,000 g/mol, about 4,000 to about 8,000 g/mol, about 3,000 to about 7,000 g/mol, about 4,000 to about 7,000 g/mol, about 3,000 to about 6,000 g/mol, or about 4,000 to about 6,000 g/mol.

In an embodiment, the block copolymer may have a Flory-Huggins interaction parameter (χ) of greater than or equal to about 0.3. The Flory-Huggins interaction parameter (χ) is defined as an A-b-C structural formula, that is, a miscibility difference due to a solubility parameter difference between an A block and a C block in a block copolymer formed of the A block and the C block bound through a covalent bond, that is, a coefficient of a degree that the A block and the C block are not mixed each other.

The Flory-Huggins interaction parameter (χ) may be expressed by the following relationship equation:

$$χ = \frac{{V}_{m}}{RT} {( {δ}_{1} - {δ}_{2} )}^{2} \qquad [ Relationship Equation ]$$

In the relationship equation,

χ is a Flory-Huggins interaction parameter,

Vₘ is a molar volume of the block that is present in a greater amount in the block copolymer including A block and C block,

R is a gas constant,

T is a temperature (K),

δ₁ is a solubility parameter of the A block, and

δ₂ is a solubility parameter of the C block.

Within the ranges, the Flory-Huggins interaction parameter may be greater than or equal to about 0.4 or greater than or equal to about 0.5.

In an embodiment, a microphase separation of the block copolymer may form a sphere, cylinder, lamellar, or gyroid phase by a segregation parameter (χ^{N}) expressed as a multiplication of the Flory-Huggins interaction parameter (χ) and a degree of polymerization (N) and a volume ratio of the A block and the C block. When a volume ratio of one block is in a range of about 0.38:1 to about 0.4:1, the gyroid phase may be formed. Also, when the segregation parameter (χ^{N}) is greater than or equal to about 15, microphase separation between the A block and the C block may be good. The segregation parameter may be for example about 15 to about 60 or about 15 to about 40. The degree of polymerization (N) is related to a weight average molecular weight of the block copolymer and may affect a thickness of the nickel oxide described below.

In an embodiment, the block copolymer may include an A block derived from an A precursor and a C block derived from a C precursor, and either one of the A block and C block may be included in an amount of greater than or equal to about 20 volume % and less than about 50 volume %, and the other one may be included in an amount of greater than about 50 volume % and less than or equal to about 80 volume %. For example, the block copolymer including the A block and the C block may include greater than or equal to about 20 volume % and less than about 50 volume % of the A block and greater than about 50 volume % and less than or equal to about 80 volume % of the C block, for example about 20 volume % to about 40 volume % of the A block and about 60 volume % to about 80 volume % of the C block.

In an embodiment, the block copolymers may include an ethylene oxide (EO) block and a propylene oxide (PO) block. For example, the A block may be an ethylene oxide block and the C block may be a propylene oxide block. For example, the block copolymer may be EO₁₉-PO₄₃-EO₁₉ (weight average molecular weight: about 4,200 g/mol, PEO: 35%), EO₂₇-PO₆₁-EO₂₇ (weight average molecular weight: about 5,400 g/mol, PEO: 35%), EO₂₀-PO₇₀-EO₂₀ (weight average molecular weight: about 5,800 g/mol, PEO: 30%), or a combination thereof.

In an embodiment, when preparing the mixture of a block copolymer and a siloxane precursor by supplying a siloxane precursor to the block copolymer, the siloxane precursor may be selectively disposed to, e.g., associated with, either the A block or the C block. The siloxane precursor may be for example tetraethyl orthosilicate (TEOS). For example, the siloxane precursor is selectively disposed in or associated with the A block to form a hydrophilic part together with the A block, and the C block may form a hydrophobic part. For example, the siloxane precursor may be selectively disposed in or associated with an ethylene oxide block to form a hydrophilic part together with the ethylene oxide block, and a propylene oxide block forms a hydrophobic part. Thus, the hydrophilic part and the hydrophobic part may be microphase-separated.

The mixture of the block copolymer and the siloxane precursor may be disposed or applied to a substrate or conductor by a method such as spin coating. The applied mixture of the block copolymer and the siloxane precursor may be self-aligned and microphase-separated.

Subsequently, a microphase-separated mixture of the block copolymer and the siloxane precursor is heat-treated to remove the block copolymer and a siloxane frame template is formed from the siloxane precursor. The heat-treating may be for example performed at about 300° C. to about 800° C. for about 10 minutes to about 800 minutes. The heat-treating may be for example performed at about 400° C. to about 500° C. for about 30 minutes to about 500 minutes. A thickness of the obtained siloxane frame may be for example about 3 nm to about 30 nm.

The obtained template may have a void formed by the removal of the block copolymer and the void may be three-dimensionally interconnected. The template may be a periodically and bicontinuously nanoporous or mesoporous structure, and may have pores of less than or equal to about 10 nm.

Subsequently, nickel may be supplied in the void of the template. The nickel may be supplied for example by electroplating (electrodeposition) or solution processes. The electroplating may be performed using a nickel plating solution including a nickel salt, and the solution process may be performed using a sol-gel precursor such as a nickel precursor.

Then, the siloxane frame is removed by selectively etching the template by dry etching or wet etching. Accordingly, the nickel filled into the void of the template may remain and may be present as a three-dimensionally interconnected nickel wire.

Then, the nickel wire is thermally oxidized to obtain a nickel oxide wire. The oxidizing may be performed at about 300° C. to about 800° C. for about 10 minutes to about 800 minutes. In an embodiment, the oxidizing may be performed for about 400° C. to about 500° C. for about 30 minutes to about 500 minutes.

The obtained nickel oxide wire may have a three-dimensionally interconnected structure, for example a triply periodic bicontinuous structure (a triply periodic minimal surface) such as a gyroid network morphology. The nickel oxide wire may have a thickness of less than about 10 nm, for example about 1 nm to about 9 nm, about 1 nm to about 8 nm, about 1 nm to about 7 nm, about 1 nm to about 6 nm, about 1 nm to about 5 nm, about 2 nm to about 9 nm, about 2 nm to about 8 nm, about 2 nm to about 7 nm, about 2 nm to about 6 nm, about 2 nm to about 5 nm, about 3 nm to about 9 nm, about 3 nm to about 8 nm, about 3 nm to about 7 nm, about 3 nm to about 6 nm, or about 3 nm to about 5 nm.

Hereinafter, an example of an electrochromic device including the aforementioned electrochromic material will be described.

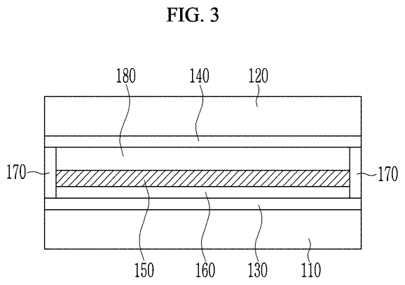

FIG. 3 is a schematic view showing an example of an electrochromic device according to an embodiment.

Referring to FIG. 3, an electrochromic device according to an embodiment includes substrates 110 and 120, a lower electrode 130 and an upper electrode 140 facing each other, an electrochromic layer 150 disposed on the lower electrode 130, and an electrolyte 180 disposed between the lower electrode 130 and the upper electrode 140.

The substrates 110 and 120 may be disposed on each surface of the lower electrode 130 and the upper electrode 140. The substrates 110 and 120 may be for example glass or a polymer and the polymer may include for example one or more of a polyacrylate, a polyethylene ether phthalate, a polyester such as polyethylene naphthalate, a polycarbonate, a polyacrylate, a polyetherimide, a polyether sulfone, or a polyimide.

The lower electrode 130 may be made of a conductive material having transparency and may include, for example inorganic conductive materials such as indium tin oxide (ITO) or fluorine tin oxide (FTO) or organic conductive materials such as polyacetylene or polythiophene.

The upper electrode 140 may be formed of a transparent or opaque conductive material, for example indium tin oxide (ITO), fluorine-doped tin oxide (FTO), a metal such as Al, antimony-doped tin oxide (ATO), or a combination thereof.

The electrochromic layer 150 may be disposed on the lower electrode 130. However, the present disclosure is not limited thereto and the electrochromic layer 150 may be disposed on one surface of the upper electrode 140. The electrochromic layer 150 may include the aforementioned electrochromic material including the nanostructure including the nickel oxide wire, and the electrochromic material is described as above.

An auxiliary layer 160 may be disposed between the lower electrode 130 and the electrochromic layer 150. The auxiliary layer 160 is a layer for improving adherence of the electrochromic layer 150, for example titanium oxide (TiO₂). The auxiliary layer 160 may be omitted as needed.

A reflector (not shown) may be formed under the upper electrode 140.

The substrates 110 and 120 are fixed by spacers 170, and the electrolyte 180 is filled between the substrates 110 and 120. The electrolyte 180 supplies an oxidation/reduction material reacting with an electrochromic material and may be a liquid electrolyte or a solid polymer electrolyte. The liquid electrolyte or solid polymer electrolyte may include an ionic material. An ionic liquid electrolyte may include, for example a solution wherein a lithium salt such as LiOH or LiClO₄, a potassium salt such as KOH, or a sodium salt such as NaOH, etc., is dissolved in a solvent, but is not limited thereto. The solid electrolyte may include, for example poly(2-acrylamino-2-methylpropane sulfonic acid) or poly(ethylene oxide), but is not limited thereto.

As described above, the electrochromic device includes an electrochromic material including the nanostructures including very thin nickel oxide wires and may greatly increase the redox sites and the surface areas and accordingly, more effectively perform the redox reactivity and exhibit improved electrochromic characteristics.

Accordingly, a contrast ratio i.e., a ratio of the transmittances in the colored state and in the bleached state of the electrochromic device, may be significantly increased. In an embodiment, the contrast ratio of the electrochromic device at a 550 nm reference wavelength may be greater than or equal to about 20:1, for example greater than or equal to about 30:1, greater than or equal to about 50:1, greater than or equal to about 70:1, greater than or equal to about 80, greater than or equal to about 90:1, greater than or equal to about 100:1, greater than or equal to about 200:1, or greater than or equal to about 300:1, for example about 30:1 to about 5000:1, about 50:1 to about 5000:1, about 70:1 to about 5000:1, about 80:1 to about 5000:1, about 90:1 to about 5000:1, about 100:1 to about 5000:1, about 200:1 to about 5000:1, about 300:1 to about 5000:1, about 30:1 to about 3000:1, about 50:1 to about 3000:1, about 70:1 to about 3000:1, about 80:1 to about 3000:1, about 90:1 to about 3000:1, about 100:1 to about 3000:1, about 200:1 to about 3000:1, or about 300:1 to about 3000:1.

The aforementioned electrochromic material and/or electrochromic device may be used in various optical devices or display devices, for example, an optical shutter, a screen for augmented reality (AR), a screen for virtual reality (VR), a smart window, a projection display device, a transparent display, and a reflection display. The optical device or display device including the electrochromic material and/or electrochromic device may be used in a wide variety of electronic devices.

Hereinafter, the embodiments are illustrated in more detail with reference to examples. However, it is understood that this disclosure is not limited by these examples.

### EXAMPLES

### Preparation Examples

### Preparation Example 1

Manufacture of Template

5.4 g of EO₂₇-PO₆₁-EO₂₇ block copolymer precursor (MW: 5,400 g/mol, PEO 35 volume %) (Pluronic® P104, BASF) as shown below is dispersed in 14 grams (g) of ethanol and stirred at room temperature for 24 hours at 500 rpm to prepare a block copolymer precursor solution (pH 9).

12.9 g of tetraethyl orthosilicate (TEOS) and 6.4 g of a diluted HCl solution (0.018 M) are mixed in 13 g of ethanol and stirred at room temperature for 30 minutes at 500 rpm to prepare a siloxane precursor solution (pH 4).

Subsequently, the block copolymer precursor solution is added to the siloxane precursor solution drop by drop until it reaches pH 7. Then, the mixed solution is allowed to stand while stirred at room temperature at 500 rpm for at least for 4 days.

To a glass substrate (3×3 square centimeters (cm²), sheet resistance 8 ohms per square centimeter (Ω/cm²) fluorine tin oxide (FTO) is applied to about 800 nm in thickness, washed with acetone, isopropyl alcohol, and deionized water respectively for 30 minutes under ultrasonic waves and additionally, treated with ozone for 30 minutes to completely remove an organic material on the surface to provide a hydrophilic surface. Subsequently, on the FTO glass substrate, a mixed solution is spin-coated at 1000 to 3000 rpm to form a thin film. Then, the thin film is dried in an oven (relative humidity 50%) to form a gyroid microstructure from an evaporation induced self-assembly (EISA) of the mixture of the block copolymer precursor and the siloxane precursor. Subsequently, the obtained gyroid microstructure is put in a quartz tube furnace and baked at 420° C. under an air atmosphere for 4 hours to manufacture a siloxane porous template.

EO₂₇-PO₆₁-EO₂₇ Block Copolymer

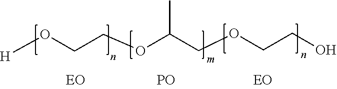

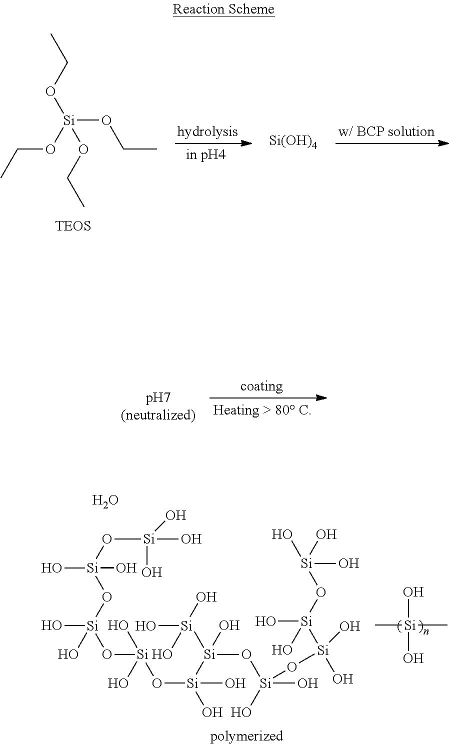

### Microphase Separation of Block Copolymer-Siloxane

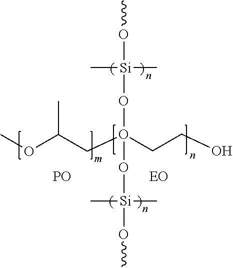

Manufacture of Nanostructure

A Watts nickel-electroplating solution (pH 5) including nickel(II) sulfate hexahydrate, nickel(II) chloride hexahydrate, and boric acid is prepared.

The nickel plating solution is supplied to the siloxane porous template under a constant voltage of 1 V by using an Ag/AgCl electrode to perform nickel electroplating at 50° C. The nickel electroplating solution readily permeate the siloxane porous template due to the template's hydrophilic character. A nickel deposition rate is about 0.3 mgC⁻¹ (milligram per coulomb) (=mg/s·A, milligram per second ampere)). When the nickel electroplating is complete, the Ni-plated siloxane template is washed with distilled water and dried. The plated template is dipped in a buffered oxide etch (BOE) etching solution for 2 minutes to selectively etch a siloxane part but leave a Ni-plated part (Ni part). Following a drying step, the Ni part is thermally oxidized under an air atmosphere at 420° C. for 8 hours to form a 400 nm-thick nanostructure that includes a brownish and semi-transparent nickel oxide (NiO) wire.

### Preparation Example 2

A nanostructure is formed according to the same method as Preparation Example 1 except that the thickness of the nanostructure is 500 nm.

### Preparation Example 3

A nanostructure is formed according to the same method as Preparation Example 1 except that the thickness of the nanostructure is 600 nm.

### Comparative Preparation Example 1

A 110 nm-thick nickel oxide (NiO) thin film is formed by electroplating using the same nickel plating solution above to form a nickel thin film on an FTO-coated glass substrate and thermally oxidizing the nickel thin film under an air atmosphere at 420° C. for 8 hours.

### Comparative Preparation Example 2

A 160 nm-thick nickel oxide (NiO) thin film is formed by electroplating using the same nickel plating solution above to form a nickel thin film on an FTO-coated glass substrate and thermally oxidizing the nickel thin film under an air atmosphere at 420° C. for 8 hours.

### Comparative Preparation Example 3

A nanostructure is formed by using a PS-b-PLLA block copolymer (polystyrene-b-poly(L-lactide), χ: −0.1, Mw: 265,000 g/mol) according to a method described in a reference article (Nano Lett, 2013, Vol. 13 No. 7, p. 3005-3010).

### Evaluation I: Analysis of Microstructure

Morphologies of the siloxane porous templates and nickel oxide are examined.

Morphology is determined using an X-ray spectrometer equipped with a high-resolution field-emission scanning electron microscopy (FE-SEM, S4800, Hitachi Inc.) and SEM. Micro-separation of NiO and oxidized NiOOH phases (NiOOH phase) is determined by using a Super-XTM XEDS detector and HR-TEM (Cs-corrected Titan G2 80-200 microscope) at 200 kV. The long-range ordering of the siloxane porous template is determined using a diffraction analyzer (X-ray diffraction, XRD, D8 Advance, Bruker) equipped with a D/Max-3B diffractometer (CuKα radiation λ=1.54 Å, 0.04 red Soller slits) ray diffraction, XRD, D8 Advance, Bruker). The transition between NiO bleached state (NiO bleaching state) and NiOOH colored state (NiOOH coloring state) is determined by Raman spectroscopy (micro-Raman S, inVia, excitation wavelength 514 nm).

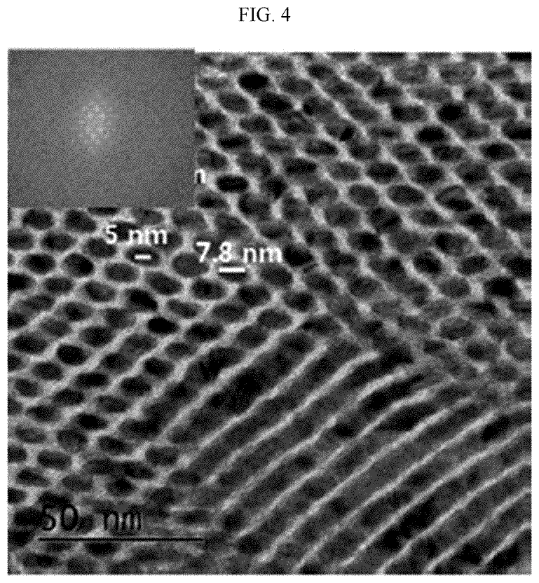

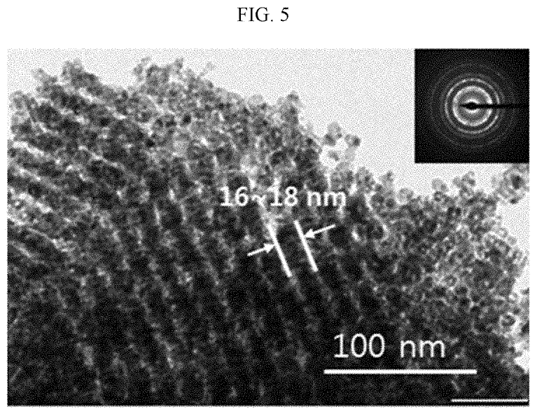

FIG. 4 is a transmission electron microscope (TEM) photograph of a nanostructure including a nickel oxide wire of Preparation Example 1 and FIG. 5 is a TEM photograph of a nanostructure including a nickel oxide wire of Comparative Preparation Example 3.

Referring to FIG. 4, the nanostructure of Preparation Example 1 is a porous structure having a nickel oxide wire of less than 10 nm thickness and specifically, about 6 nm in thickness. In comparison, referring to FIG. 5, the nanostructure of Comparative Preparation Example 3 is a porous structure including a nickel oxide wire of about 16 to 18 nm in thickness.

In addition, the nanostructure including the nickel oxide wire of Preparation Example 1 has a surface area of about 800 cm²/g and a porosity of about 60%. In contrast, the nickel oxide thin film of Comparative Preparation Example 1 has a surface area of less than about 30 cm²/g and a porosity of less than about 10%, and the nanostructure including the nickel oxide wire of Comparative Preparation Example 3 has a surface area of less than 100 cm²/g and a porosity of less than 60%.

Accordingly, the nanostructure including the nickel oxide wire of Preparation Example 1 has an increased surface area and/or porosity compared with those of the nickel oxide thin film of Comparative Preparation Example 1 and the nanostructure of Comparative Preparation Example 3.

### Evaluation II: Analysis of Electrochemical Characteristics

A change in transmittance between a bleached state and a colored state is examined by using a UV-Vis spectrometer (Varial Cary 5000). Electrochemical characteristics such as cyclic voltammetry and chrono-amperometry are evaluated in three-electrode electrochemical compression cell using PARSTAT-22 (Princeton Applied Research). A platinum foil and Ag/AgCl are respectively used as a counter electrode and a reference electrode. A 1 molar (M) KOH aqueous solution is used as an electrolyte. The cyclic voltammetry of the NiO nanostructures is evaluated at a scan rate of 20 millivolts per second (mVs⁻¹) at room temperature within a potential range of 0.1 volts (V) to 1 V.

Contrast ratios of the nanostructures of Preparation Examples 1 to 3 and the nickel oxide thin film or the nanostructure of Comparative Preparation Examples 1 to 3 are evaluated.

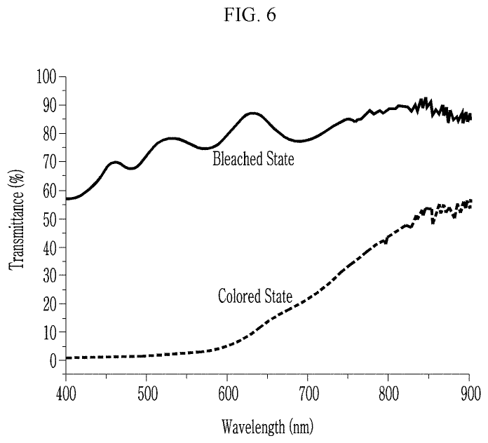

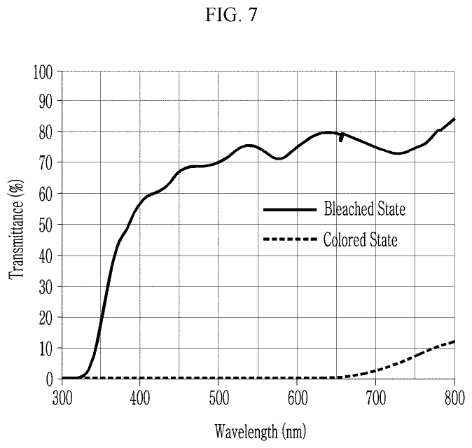

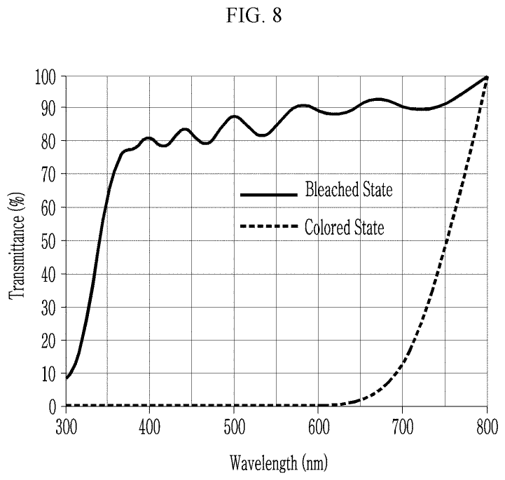

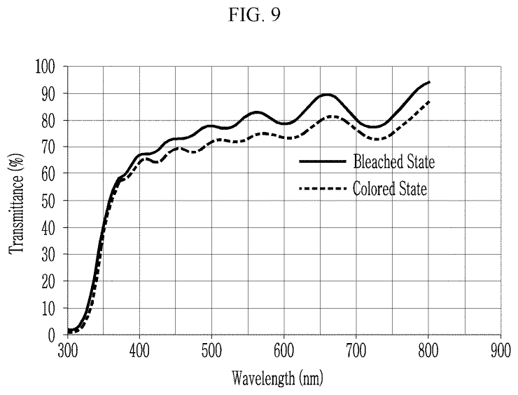

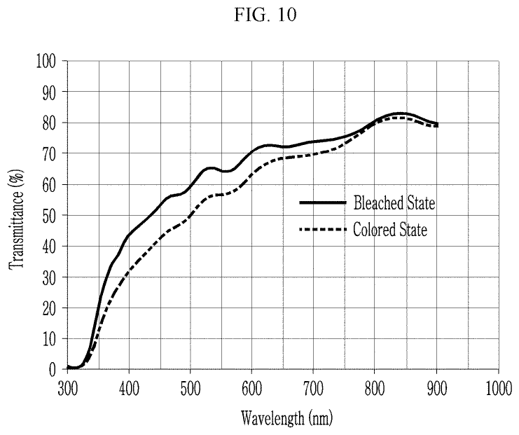

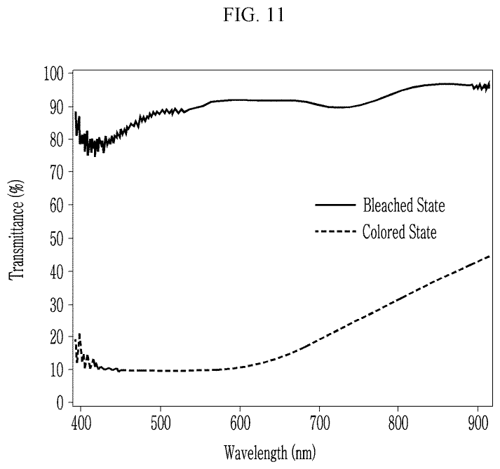

FIG. 6 is a graph showing transmittances of the nanostructure of Preparation Example 1 in a bleached/colored state, depending on a wavelength. FIG. 7 is a graph showing transmittances of the nanostructure of Preparation Example 2 in a bleached/colored state, depending on a wavelength. FIG. 8 is a graph showing transmittances of the nanostructure of Preparation Example 3 in a bleached/colored state, depending on a wavelength. FIG. 9 is a graph showing transmittances of the nickel oxide thin film of Comparative Preparation Example 1 in a bleached/colored state, depending on a wavelength. FIG. 10 is a graph showing transmittances of the nickel oxide thin film of Comparative Preparation Example 2 in a bleached/colored state, depending on a wavelength. FIG. 11 is a graph showing transmittances of the nickel oxide thin film of Comparative Preparation Example 3 in a bleached/colored state, depending on a wavelength.

Table 1 shows transmittance of devices manufactured with nanostructures of Preparation Examples 1 to 3 and the nickel oxide thin film or the nanostructure of Comparative Preparation Examples 1 to 3 in a bleached/colored state at a wavelength 550 nm. The contrast ratios are listed as a ratio of the transmittance in the bleached state and the transmittance in the colored state.

TABLE 1

| | T₁ | T₂ | Contrast ratio |
|---|---|---|---|
| | (bleached state) | (colored state) | (ΔT, |
| Example | (@550 nm, %) | (@550 nm, %) | @550 nm) |
| Preparation Example 1 | 78 | 0.98 | 80:1 |
| Preparation Example 2 | 75 | 0.0617 | 1215:1 |
| Preparation Example 3 | 88 | 0.0236 | 3729:1 |
| Comparative | 80 | 71.4 | 1.12:1 |
| Preparation Example 1 | | | |
| Comparative | 65 | 57.0 | 1.14:1 |
| Preparation Example 2 | | | |
| Comparative | 80 | 10 | 8:1 |
| Preparation Example 3 | | | |

Referring to Table 1 and FIGS. 6 to 11, the nanostructures of Preparation Examples 1 to 3 exhibit significantly greater contrast ratios compared with those of the nickel oxide thin film or the nanostructure of Comparative Preparation Examples 1 to 3.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. An electrochromic material comprising a nanostructure comprising a nickel oxide wire which is three-dimensionally interconnected,
wherein a thickness of the nickel oxide wire is less than about 10 nanometers.

2. The electrochromic material of claim 1, wherein the nanostructure is porous.

3. The electrochromic material of claim 2, wherein the nanostructure is a nanoporous structure or a mesoporous structure.

4. The electrochromic material of claim 2, wherein a pore size of the nanostructure is less than or equal to about 10 nanometers.

5. The electrochromic material of claim 1, wherein a surface area of the nanostructure is greater than or equal to about 100 square centimeters per gram.

6. The electrochromic material of claim 1, wherein a thickness of the nickel oxide wire is about 1 nanometer to about 8 nanometers.

7. The electrochromic material of claim 1, wherein the nanostructure is a triply periodic bicontinuous structure.

8. The electrochromic material of claim 1, wherein the nanostructure has a gyroid network morphology.

9. A method of manufacturing an electrochromic material, comprising
preparing a template having a void which is three-dimensionally interconnected,
providing nickel to the void of the template,
removing the template, and
oxidizing the nickel to form a nanostructure comprising a nickel oxide wire which is three-dimensionally interconnected,
wherein a thickness of the nickel oxide wire is less than about 10 nanometers.

10. The method of claim 9, wherein the preparing of the template comprises performing a microphase separation of a mixture of a block copolymer and a siloxane precursor,
wherein the block copolymer has a weight average molecular weight of less than or equal to about 10,000 g/mol and a Flory-Huggins interaction parameter of greater than or equal to about 0.3.

11. The method of claim 10, wherein
the block copolymer comprises an ethylene oxide block and a propylene oxide block, and
the ethylene oxide block is included in an amount of greater than or equal to about 20 volume % and less than about 50 volume % with respect to the block copolymer, and
the microphase separation is phase-separation into a hydrophilic part comprising a structural unit derived from the siloxane precursor and the ethylene oxide block and a hydrophobic part comprising the propylene oxide block.

12. The method of claim 9, wherein the providing of the nickel to the void of the template is performed by an electroplating or solution process.

13. An electrochromic device comprising
a first electrode and a second electrode facing each other,
an electrochromic material on one of the first electrode and the second electrode, and
an electrolyte between the first electrode and the second electrode,
wherein the electrochromic material comprises a nanostructure comprising a nickel oxide wire which is three-dimensionally interconnected, and
a thickness of the nickel oxide wire is less than about 10 nanometers.

14. The electrochromic device of claim 13, wherein the nanostructure is a nanoporous structure or a mesoporous structure.

15. The electrochromic device of claim 13, wherein a pore size of the nanostructure is less than or equal to about 10 nanometers.

16. The electrochromic device of claim 13, wherein a surface area of the nanostructure is greater than or equal to about 100 square centimeters per gram.

17. The electrochromic device of claim 13, wherein a thickness of the nickel oxide wire is about 1 nanometer to about 8 nanometers.

18. The electrochromic device of claim 13, wherein the nanostructure is a triply periodic bicontinuous structure.

19. The electrochromic device of claim 13, wherein the nanostructure has a gyroid network morphology.

20. The electrochromic device of claim 13, wherein a contrast ratio of the electrochromic device at 550 nanometers is greater than or equal to about 80:1.

21. An electronic device comprising the electrochromic device of claim 13.

22. An optical device comprising the electrochromic material of claim 1.

23. An electronic device comprising the optical device of claim 22.
